(19) United States
(12) Patent Application Publication
(10) Pub. No.: US 2025/0209460 A1
(43) Pub. Date: Jun. 26, 2025

(54) METHOD AND APPARATUS FOR BIOMETRIC PAYMENT AUTHENTICATION

(71) Applicant: PopID, Inc., Diamond Bar, CA (US)

(72) Inventors: John Miller, Diamond Bar, CA (US); Sean Olson, Diamond Bar, CA (US); Ashish Gupta, Diamond Bar, CA (US); Seveda Abraamyan, Diamond Bar, CA (US); Henning Zieger, Diamond Bar, CA (US); Tom Costello, Diamond Bar, CA (US); Tony Lomelino, Diamond Bar, CA (US)

(21) Appl. No.: 18/936,547

(22) Filed: Nov. 4, 2024

Related U.S. Application Data
(60) Provisional application No. 63/606,178, filed on Dec. 5, 2023.
(60) Provisional application No. 63/665,899, filed on Jun. 28, 2024.
(60) Provisional application No. 63/688,850, filed on Aug. 29, 2024.

(51) Int. Cl. G06Q 20/40; G06Q 20/20

(52) U.S. Cl. CPC G06Q 20/40145; G06Q 20/20

(57) ABSTRACT

The present invention relates to a method and apparatus for biometric identification for use in connection with a payment or transaction based system, a stand alone and retrofit module for carrying out the same.

### RELATED APPLICATIONS

The present application claims priority to and incorporates by reference U.S. Patent Application No. 63/606,178 filed on Dec. 5, 2023, Ser. No. 63/665,899 filed on Jun. 28, 2024, and Ser. No. 63/688,850 filed on Oct. 21, 2024.

### BACKGROUND OF THE INVENTION

### Field of the Invention

The present invention relates to a method and apparatus for biometric identification for use in connection with a payment or transaction-based system, and a stand alone and retrofit module for carrying out the same.

### Background

Automated online and retail payment systems, including those used for rewards and customer loyalty systems, are well known in the prior art. In retail settings these systems involve the use of some type of a point of sale (POS) terminal. The POS terminal can take many forms, from a stand-alone terminal connected to a cash register, a tablet computer running a POS application, a grocery store self checkout station, or terminals built into other devices like gas pumps, vending machines, ATMs, kiosks, and other variations.

Each such system has the ability to read a credit/debit card either by swiping the card through a magnetic card reading strip, or through the use of a card chip reader. Further, POS systems are typically enabled with near field communication (NFC) technology, which can read a card that is in very close proximity to the terminal by interacting with the chip on the card. Further still, typically terminals can also interface using NFC technology to communicate with a payment application running on a smart phone such as Apple Pay or Google Pay. This allows a user to pay using their phone as a proxy for the credit card, by holding the phone near the POS terminal.

Online systems often require manual entry of credit card and other authentication information, but computing devices (especially mobile devices) can be equipped with card reading modules that allow for automatically entering credit card information in a manner similar to what is described above in reference to retail systems.

Once the payment information is entered in the POS system, payment processing proceeds in a manner well know in the art.

POS systems of the type describe above suffer from a number of drawbacks. First, the system generally requires the user to present their card at the time of purchase. This creates an opportunity for the card to be lost, misplaced, stolen, or otherwise compromised. Credit card fraud is a huge problem, which is only exacerbated by requiring card holders to carry their cards on their person and present them to the POS system at the time of purchase.

Further, user not only have to carry their cards on them they have to remove the card from their purse or wallets, and then return them thereto after payment. This is a cumbersome process at best, especially in a retail setting where the user may have their hands full of merchandise or other items.

Also, if for some reason the user has forgotten or misplaced their card, the purchase cannot be completed.

Mobile payment systems, which relay on an application running on a smart phone and NFC technology to transmit the card information to the POS system, suffer from the same drawbacks. These systems do not require the physical presence of the card, but they do require the user have their phone with them and require that they open the phone or otherwise manually enable the payment application which is similarly cumbersome, and creates risk that the phone can be lost, stolen, or compromised.

A further problem comprises the fact that payment and transactions systems vary widely in size, shape, and platform/system requirements. Even those that can perform some limited biometric processing are typically incompatible with each other. A drawback of these systems is that to upgrade to better identification systems requires replacing equipment, and even then, each system only talks to itself making deploying a cross-platform identification software and hardware solution heretofore impossible.

Thus, a need exists for a system and method for processing payments that completely or substantially eliminates the problems of the prior art.

### BRIEF DESCRIPTION OF THE FIGURES

FIG. 1 is a perspective view of a payment terminal and biometric module of the present invention.

FIG. 2 is a perspective view of the payment terminal and biometric module.

FIG. 3 is a side view of the payment terminal and biometric module.

FIG. 4 is a perspective view of the payment terminal and biometric module.

FIG. 5 is a side view of the payment terminal and biometric module.

FIG. 6 is a perspective view of the payment terminal and biometric module.

FIG. 7 is a side view of the payment terminal and biometric module.

FIG. 8 is a side view of a body of the biometric module.

FIG. 9 is a partial side view of the body and feet of the biometric module.

FIG. 10 is a side view of the body and feet of the biometric module.

FIG. 11a is a side view of the body and feet of the biometric module with an axial connection.

FIG. 11b is a side view of the body and feet of the biometric module with a spherical connection.

FIG. 12 is a side view of the body and feet of the biometric module with a ball connection.

FIG. 13 is a close up view of a portion of FIG. 12.

FIG. 14 is a side view of the body and feet of the biometric module with a ball connection.

FIGS. 15a, b, and c are side views of various types of feet of the biometric module.

FIGS. 16a, b, and c are side views of various types of feet of the biometric module.

FIG. 17 is a side view of the feet of the biometric module having adhesive.

FIGS. 18a and b are side views of the feet of the biometric module having spikes.

FIG. 19 is a side perspective view of the feet of the biometric module with a threaded connection.

FIG. 20 is a side view of the feet of the biometric module with a ratcheted connection.

FIG. 21 is a schematic of the electrical connection of the biometric module.

FIG. 22 is a first perspective view of a retrofit module.

FIG. 23 is a second perspective view of a retrofit module.

FIG. 24 a and b are a top and side views of the retrofit module.

FIG. 25 a and b are side view of the retrofit module connected to a POS device.

FIG. 26 is a perspective view of the retrofit module.

FIG. 27 is a perspective view of the retrofit module connected to a POS device.

FIG. 28 is a perspective view of the retrofit module brackets, and a POS device.

FIG. 29 is a perspective view of the retrofit module brackets, and a POS device.

FIGS. 30a-d show installation steps for connecting the retrofit module to a POS device.

FIG. 31 is a schematic of the retrofit device.

FIG. 32 is an internal view of the retrofit device.

FIG. 33 is an internal view of the retrofit device.

FIGS. 34a-c are views of a case for connecting the retrofit module to a POS device.

FIGS. 35a-c are views of a case for connecting the retrofit module to a POS device.

FIGS. 36a-c are views of a case for connecting the retrofit module to a POS device.

FIGS. 37a-c are views of a case for connecting the retrofit module to a POS device.

FIGS. 38a-h are views of a case for connecting the retrofit module to a POS device.

FIGS. 39a-h are views of a case for connecting the retrofit module to a POS device.

FIGS. 40a-h are views of a case for connecting the retrofit module to a POS device.

FIGS. 41a-h are views of a case for connecting the retrofit module to a POS device.

### DETAILED DESCRIPTION OF THE PREFERRED EMBODIMENTS

In the Figures, a system and method for biometric based payment authentication in POS systems is shown and disclosed. Biometric authentication for online and retail payments offers substantial benefits versus existing methods thereby eliminating the problems associated with the prior art. The present invention comprises a system of hardware and software that enables effective biometric authentication for loyalty, rewards, login, order history, payments, and a range of other applications in retail and online environments. This system of providing biometric authentication to businesses and consumers shall be referred to herein generally as a biometric authentication and payment system (BAPS).

The general architecture for the system comprises the following required and optional components and functions:
A software based, preferably SaaS based, registration system for a user to register a facial image (or set of images). The user establishes an account, with a username and password (along with any other suitable authenticating information). The user provides the aforementioned authenticating image(s), which will be used by the BAPS to authenticate purchases or conduct any other activities described or referenced herein. The authentication image provided for registration may be termed the registration image.
The system uses software to obtain a biometric vector from the registration image, hereafter the registration vector.
The user's mobile phone for interfacing with the registration system, including providing both registration and authenticating images, which can be taken with the phone's camera.
The user's payment credentials and method, which will be associated with the biometric account they create or have created with the BAPS.
A retailer's terminal or an ordering terminal, register, or kiosk for carrying out payment processing-the POS system/device.
A biometric module for interfacing with the retailer's POS system, such module either built into or attached to the POS system or built into or attached to the retailer's payment terminal (which is connected to the retailer's POS system), wherein the module is equipped with a device for capturing biometric information consistent with the BAPS requirements. The biometric module is capable of taking biometric images and may be termed a biometric camera module or retrofit biometric camera module.
A transaction image (or set of images) taken by the biometric module when the user wishes to use the BAPS for a transaction.
A biometric vector obtained from the transaction image, hereafter the transaction vector.
A cloud-or edge-based software system interfacing with the biometric module and the registration system for processing the transaction, registration, and authentications image for a match.

The present invention can be deployed in many operating environments. The following is illustrative of one such environment, but the invention is not limited hereto. In the case where the biometric identification information comprises images of the user's face and the BAPS is implemented on cloud-based servers (hereafter, BAPS Cloud), the following procedures are employed.

A user wishing to register for a biometric account with the BAPS uses their mobile phone, or other computing devices, to navigate to an account creation or sign-up page either on a website or provided through an application downloaded to the user's device. The user either creates an account and then enters their personal information, comprising name, mobile number, email address (that may be verified using one or more commercially available services or verification techniques), and any other requested information. Once the verification is complete the user is then prompted to submit their biometric information.

In the case of a system using facial recognition, the user takes at least one picture of their face (preferably with their mobile device), or in some implementations can upload a previously taken picture. In some implementations, as described later in this document, the user provides multiple photos or a video at various angles to enhance the accuracy of the subsequent recognition process.

The facial detection algorithm on the user's device, or in some implementations in the BAPS Cloud, evaluates the image taken by the user to ensure that it is an image of a live person using any of a number of commercially available liveness/anti-spoofing algorithms. This can include single RGB image based neural net models provided by a number of companies including ID R&D, RGB and NIR image based neural net models provided by a number of companies including Alchera, active liveness algorithms, depth sensor based algorithms, and reflectivity sensor based algorithms.

If the image does not pass this test, the account creation attempt is rejected. If the image does pass this test, then personal and biometric information is validated and is sent to the BAPS Cloud. In the BAPS Cloud, the user's biometric data is transformed into a biometric vector (the registration vector) using a commercially available facial recognition algorithm such as referenced above. At this point, the user's BAPS account is created and the user is given an opportunity to associate one or more payment methods, rewards, loyalty information for retailer loyalty programs, or any other consumer account associated with POS systems in their BAPS account.

When a user enters a retail store and wishes to use their BAPS account such as as a retail location to make a purchase, check in to the retailer's loyalty system, or other purpose, the user approaches the POS terminal or kiosk to which the biometric module is a part thereof. The user will position their face in close proximity to the module, and push an on-screen button to give their consent or otherwise give their consent via other means to have their image taken and used to identify them or otherwise initiate the process in accord with the requirements of the POS or BPAS system. Once the process is initiated, the system captures an image or series of images of the user's face and uses any of a number of commercially available techniques to determine that the user seen by the camera is a live person, including convolutional neural network (CNN)-based single frame anti-spoofing or multi-spectral RGB NIR image analysis and other techniques described above. Once the user has been confirmed to be a live individual, the user's image is taken (or an image taken as a part of the aforementioned liveness check is used) and sent to the BAPS Cloud for vectorization for creation of a transaction vector. The transaction vector is then compared to the BAPS database of the registration vectors to find a match from the database of registered users using techniques well understood by those skilled in the art.

If a match is found, the BAPS returns a retailer-specific unique user ID (UUID) for the user and, in some cases, other relevant information including the user's identifier or PIN to complete the transactions, which could include payment information, or information associated with the retailer's loyalty or rewards program. The retailer's POS or payment terminal then uses the UUID and any other information returned to enhance the user's ordering process, e.g., the user's past orders and preferences, or otherwise complete the transaction such as making payment using the payment methods associated with their account.

Additional aspects of the present invention, and improvements on the prior art include the following. Prior art facial re

[symbol]

cognition-based systems have limitations on their ability to differentiate individuals based on facial data alone. The present invention collects a facial image of at least some portion of the iris, typically taken in near infrared (NIR), whereby the accuracy of recognition can be enhanced. The iris data, or partial iris data, can be employed in various ways, a few of which are described below.

First, the iris data can be vectorized along with the image of the face into a single biometric vector and used to train a convolutional neural network (CNN) for enhanced facial recognition. Second, the iris data can be vectorized on its own and used to train an iris-data specific CNN. This CNN would be called either before or after the above identification process where the face was used, for additional or more secure verification.

Another embodiment of the present invention comprises the using a NIR image of the face either in combination with a RGB image of the user's face or on a standalone basis for liveness, matching, or both. The images could be combined with other biometric data as well, including iris or partial iris captures.

The present invention also can utilize database sharding which is a method of splitting a large database into smaller, more manageable parts, called shards, and storing them across multiple database servers. For example the database can be sharded based on location of the retailer, or the user, which enables the biometric recognition process to be performed on smaller data sets which produces more accurate results in less time. One piece of data that can be used for sharding, particularly for in-person retail transactions, is location data.

Location data comprises both real-time data on location, such as GPS, cell tower, WiFi names, UWB, or Bluetooth beacon data, as well as data that enables prediction of location, such as location data from previous transactions.

An additional method for obtaining location data is via a Bluetooth or UWB beacon placed on site at the retailer's location, such as in a camera module attached to a self-service kiosk or POS system. Under this method, an app on the user's phone would watch for a signal from the Bluetooth or UWB beacon, according to one of the various standards available, e.g., iBeacon, EddyStone, etc.

Once the Bluetooth or UWB signal is detected, the app would notify the BAPS Cloud that the user is present at a certain retailer location, which information can then be used by application as noted (for example for sharding the database, for primary and secondary identity verification purpose), or otherwise to narrow the list of users that might be performing a transaction

The BAPS Cloud in this manner can use this information to include the user's biometric vector in the set of vectors that are compared to the transaction image vector to determine the identity of the user. The system can also reduce the size of the database used to identify the user to just the number of registered users present at a given retailer location as opposed to the full database of users in the BAPS.

Such a system would also give the user of the BAPS full control over whether they appear in a given search as they could simply disable the app that is looking for the signal from the beacon on their phone for security, privacy or confidentiality purposes.

In another embodiment of the present invention, the registration vector could be stored on the user's mobile phone, along with or instead of in the BAPS Cloud. The vector would still be sent to the BAPS Cloud for recognition purposes upon initiation of a transaction where the user has at the moment or previously chosen that they would like to be identified. Such a system would limit central storage of biometric information by sending the registration and transaction vector at the same time thereby eliminating the need to search the database for a match. Such a system could also provide the user with more comfort and security with the BAPS. In another implementation, the registration vector stored on the user's mobile phone could be compared to the transaction image via vectorization of the transaction image on either the user's mobile phone or the payment terminal. The images and/or vectors in such a scenario could be transmitted via Bluetooth, UWB, or WiFi.

Also, for fraud detection purposes it can be helpful for the system to capture images of a person who is performing a transaction in the event that they deny that they performed the transaction as a part of an attempt to commit financial fraud. This can be done with an instore security camera or a camera on the POS system or kiosk for example, or with the BAPS system.

The system can also be configured to use a user's palm for identification by using existing algorithms for taking palm vein scans as a method for biometric authentication, where a user's unique palm vein pattern or palm print or hand shape or any combination thereof is used for identification. For palm vein, the process involves using a camera capable of imaging in the NIR range to capture the vein pattern and create a digital template. This can be used instead of or in combination with facial recognition techniques.

Various devices can be incorporated into the integrated sensor module for face and palm, including combined RGB NIR sensors, Bluetooth beacons, ToF sensors or structured light sensors (ToF is a device that measures the distance between an object and itself by using light or electromagnetic waves), using structured light emitter for IR illumination, separate IR emitters such as in lightbulbs, synced to facial recognition, use of mobile phone to signal kiosk or payment terminal via bluetooth, NFC, and the like.

Further the BAPS system can perform facial recognition where multiple recognition images are taken across multiple transactions and compared across several images for making identification.

In an additional implementation, the user may be required to perform a specific motion during the recognition process associated with the transaction to capture the user's face at multiple pose angles. Such specific motions can include nodding and turn one's head to the side. Those specific motions may be initiated based on instructions from the BAPS system.

For security purposes the system can utilize software or hardware encryption to transmit images from place to place.

In any biometric recognition system, it is possible that an image search will return multiple matches along with associated numerical values to approximate the likelihood that a user's transaction vector matches any particular registration vector, hereafter called the match percentage. Often, the result with the highest match percentage is returned, however, if multiple results are returned that exceed that defined match percentage it may be deemed an error condition and the system returns an error.

As such, in these situations there is systematic tradeoff between obtaining a single result and failing to identify a given user due to less than optimal image quality or other issues that can affect the matching algorithms. Such tradeoffs are typically described in terms of false positive results (FPR) and false negative results (FNR).

In the present invention, a multi-threshold system is implemented in the BAPS to eliminate this tradeoff. In such an implementation, when a user submits a transaction image, the system performs a liveness check for authentication purposes which can include passive, active, and hybrid checks. Passive checks do not require user input and can involve for example scanning for natural movements. Active checks use some form of user input such as a user challenge test. A hybrid approach combines the two. The system also checks the image quality, crops the image, and then runs it in a one to many (1:N) match against the database of registered users.

The above techniques reduce the chances of multiple matches, however, the facial recognition system (which may be a commercially available system from vendors like SoftBank, Paravision, and NEC) can still return multiple matches. The present invention resolves this problem in reference to two numbers. The first is the called the lower threshold (LT), which represents a predetermined lowest acceptable threshold for a match. The second number is an upper threshold (UT) which represents a predetermined upper or maximum threshold where a match is considered certain.

The following cases are considered:
Case 1—a single match that exceeds the LT and UT, this is the most common case and the easiest to resolve. The match is confirmed and the transaction proceeds.
Case 2—a single match above the LT but below the UT, in this case a match is suspected but not confirmed and the system performs some form of a liveness check. Preferably, the user is asked for a PIN that they set up during account creation. If the user is able to submit the PIN correctly, the match is confirmed and the transaction proceeds. If the user fails to enter the PIN a certain number of times (3 for example) the match is not confirmed and the user's account is locked based on suspicion of fraud (additional verification steps can be taken at a later time to unlock the account).
Case 3—multiple matches above the LT or the UT, this case is treated the same at the Case 2 where a PIN is requested.

This approach, substantially increases the accuracy of matches and effectively balances the rate of FPRs and FNRs, while minimizing the impact on users.

The present invention comprises a novel approach for using biometric identification for all kinds of payments, including credit/debit cards, rewards and loyalty, ACH, and the like. A further aspect of the present invention is to use the systems, methods, and devices described herein to enable interoperability across different biometric payment platforms on a single machine such that a user does not need to interact with the system to select between specific payment or biometric platforms they wish to use to authenticate payment or transactions. In accord with the invention, a user can present themselves and their associated biometrics in front of the biometric reader on the payment machine without having to specify which biometric service they would like to use to pay. Such an approach simplifies the biometric payment process for consumers, enabling faster and easier payments.

In addition, the present invention includes systems, methods, and devices to improve the accuracy of biometric recognition in biometric payment systems.

One embodiment of the present invention comprises systems, methods, and devices for wireless communication between a user's mobile device and a payment terminal that informs the payment terminal which biometric payment platform the user wishes to use. The wireless communication can be based on Bluetooth, ultrawide band technology (UWB), or another wireless communication protocol. Based on the information transferred wirelessly and automatically from the user's mobile device to the terminal, the biometric switch in the biometric module or device can automatically configure itself to capture the correct biometric data and route the transaction to the preferred biometric pay platform without the user needing to push a button or specify which specific platform he or she would like to use. In cases where the payment terminal does not receive the information about the biometric payment platform that the user wishes to use or if the terminal receives information from multiple user mobile phones that designate different biometric payment platforms and is not able to correlate the information received to the specific user making a payment, the terminal will ask the user to manually select the platform that he or she wishes to use to pay, typically via a set of on-screen buttons, or otherwise provide a means of authentication necessary to make the selection.

In a further embodiment, an app on a user's mobile phone is configured to wirelessly broadcast information conveying that the user has a biometric payment account on a specific biometric payment platform. The broadcast of such information by the user's mobile phone can be constant or it can triggered by a beacon in a retail store, e.g., a Bluetooth beacon, that the app is listening for, by location data obtained by the mobile device, e.g., from cell towers or GPS indicating that the user is present in a retail store, by a wireless signal from the payment terminal, e.g., UWB, by the presence of certain wireless networks, or by other means.

Upon receiving the information, the payment terminal may configure itself to capture the biometric information associated with the specific biometric payment platform specified in the information and route the transaction accordingly. For example, if the user has an account with a biometric service (such as Amazon's) for palm-based payment, the local application on the user's mobile phone will be configured to broadcast that information. When the payment terminal receives that information, it will configure itself to capture the biometric data required for authentication and payment with AmazonOne. Such configuration changes comprise camera settings, liveness algorithms, user interface, and routing of the transaction. Once the payment terminal has configured itself for AmazonOne, the user is able to simply present his or her palm to make the payment.

In cases where there are multiple users whose phones are broadcasting information with different payment platforms in proximity to the payment terminal, the present invention includes methods for determining which information should be applied for the user who is making a payment. In the case where the information is conveyed by Bluetooth or UWB, the payment terminal will use various techniques, well known to those skilled in the art, to determine the distance of the mobile phone from the payment device and will then use the information provided by the mobile phone that is closest to the payment terminal. In some implementations, additional data is used to determine which user is trying to pay, comprising velocity, acceleration, and sound levels, e.g., audible or inaudible sounds emitted by the payment terminal.

In a further embodiment, the user's mobile phone is not only broadcasting that the user has an account with a specific platform but is also broadcasting a unique identifier so that the payment terminal receiving the information is able to distinguish among individual information broadcasts sent by the mobile phones of users in a specific location where biometric payment will take place. Such additional information can simplify the task of determining which user is actually making a transaction and, correspondingly, how the payment terminal should configure itself.

In some implementations, where multiple payment terminals are present, the information signals from a user's mobile phone may be captured by the multiple payment terminals. In such cases, the multiple payment terminals may communicate with each other data on the individual information signals they receive in order to better determine which individual is intending to pay and which terminal they intend to use. Such data comprises, signal strength, sound levels, position, velocity, acceleration, and distance from the payment terminal.

In some implementations, in cases where users have multiple biometric payment apps on their mobile devices, each time a user installs or uses a biometric payment app, they will be asked by that app for their preference on how and when they would like that specific biometric payment platform to be displayed when biometric payment is available in a given location on a given payment terminal. For example, the user may be asked if they would like to make a biometric payment platform their primary biometric payment platform, i.e., the biometric platform that should be used any time that specific biometric payment terminal is available on a payment terminal. In such cases, the information broadcast by the user's mobile phone will include that preference information. Similarly, the user may choose other preference options, such as to designate specific biometric payment platform for given retail establishment.

In some implementations, the information may be broadcast by the app of the retailer where the user will be paying. In such cases, users may select in the retailer's app the specific biometric payment platform or platforms they would like to see when they go to pay. In some implementations, the user connects their loyalty information to this specific biometric authentication method.

In another embodiment, the information broadcast by an app on the user's mobile phone may include a unique identifier for the user. In such cases, the biometric payment terminal will use that information to perform a biometric match against a single user in the database rather than across multiple users thereby improve reducing the risk of a false positive in the biometric recognition.

In some implementations, the payment terminal will receive multiple unique identifiers but will not be able to determine which unique identifier is associated with the user that is currently trying to pay. In such cases, the payment terminal will perform a biometric match vs. all the users associated with the unique identifiers it detects. In some implementations, the payment terminal will be able to determine that only a subset of the unique identifiers it detects are users who might be paying and will perform a match against that subset of users.

In some embodiments, the unique identifier changes at certain intervals according to a predefined algorithm that is implemented either on a centralized server or on the user's mobile device. In some implementation, public/private key encryption is used for the unique identifiers.

In some embodiments, the unique identifier is pulled by the app from a central server via the mobile phone's internet connection. Updates to the unique identifier associated with the user may also be pushed by a central server to keep the information current.

In some embodiments, the update to the unique identifier is triggered by a specific event, presence at a certain location, a set time interval, and a random time interval.

Note that the unique identifier can be transmitted by the user's mobile phone independent of their biometric payment preference.

In some embodiments, when the payment terminal receives the unique identifier, it queries a central server in the cloud to determine the user's biometric payment preference.

The present invention substantially eliminates the problems of the prior art discussed above by providing a system and method for the use of a standardized payment method and/or apparatus especially as associated with biometric payment systems.

In a further embodiment of the invention, in the event there is no wireless handshake between a phone and a terminal, the user can provide a PIN code which serves as a user identifier and an identifies the user's payment platform preferences. The PIN codes must be unique not only to an individual and across one particular platform, but across all possible platforms that the device so it is known which platform to route to the transaction. For example, each platform can have a unique coded number at the start of the PIN to identify the platform In other words, in the absence of phone passing identifier for the consumer biometric service, typing in the PIN ensures seamless routing to the service along with biometric information.

Further, the Figures show various embodiments of the present invention, which includes a module added to retrofit existing payment terminals thereby making the module universally adaptable. The biometric module uses a mounting device that can adhere to an existing terminal and a connector such as a USB cable, or other similar means, to attach to the terminal. The biometric device is adaptable to interface with the devices as shown, as well as other devices in a similar manner.

The biometric system described herein can be deployed as a stand alone device that integrates with the components of standard payment or transaction based systems. Many of those systems already have cameras that can be used for image taking. Many systems, however, such as existing POS systems in retail environments or in services establishments like restaurants do not have cameras.

Most restaurants and retail stores today do not have the camera hardware on existing payment machines (including those described above) which are required for biometric image based authentication. Restaurants and retailers may not wish to replace existing systems and install separate machines for biometric payment authentication. And even when cameras are embedded in acceptance machines, they are generally a single RGB camera and are therefore not ideally suited for effectively authenticating both face and palm transactions.

The present invention solves this problem by providing not a mechanical apparatus for attaching a camera/biometric identification module to a standard prior art payment terminal. Another embodiment of the invention is a payment terminal that accepts biometric authentication of different biometric authentication platforms.

One embodiment of the invention is a payment terminal that accepts authentication based on payment cards and through mobile devices (NFC or QR code) and has a camera module that authenticates images of a users face or a user's palm scan in a singles device in opposition to the prior art. Face and palm identification systems utilize different techniques and algorithms that focus on different focal points of the palm and face which has prevented the use of a single device to do both. The present invention has overcome the limitations of the prior art through various novel techniques described herein.

First, the present invention can use a single camera to adjust the lens to achieve clear focus of the palm at a certain range and clear focus of the face at a different range. For example, the camera can focus on the palm at as close as about 6 centimeters while focusing on the face at a distance up to about a meter are optimal ranges, however, the exact ranges can and will vary depending on the application, equipment, and other factors.

Another embodiment of the invention is a mechanical apparatus for attaching the camera module to any payment terminal for the purpose of retrofitting existing payment or transaction based terminals. The present invention is adaptable for use with payment terminals in a wide range of shapes and sizes, from a width of between 2.9 to 3.1 inches for units that are generally considered hand-held or portable units to from 6 to 8 inches in width for units that are generally considered fixed units mounted to a stationary bracket. The embodiment is also compatible with POS systems.

The present invention works with units that have no camera, or supplements units with existing cameras since these units typically do not contain biometric capturing components that have the utility of the present invention. In addition, prior art terminals that do contain cameras are often in a single position fixed relative to the payment terminal and cannot be moved, which causes difficulties in properly capturing a face or palm because the captured image may not contain the desired biometric information.

Biometric capturing components mounting approaches and methods are described herein to solve these problems and to provide a secure, fixedly attached connection to existing payment terminals that allow spatial and directional positioning of the biometric capturing components and thus gain the correct angle to capture the desired image.

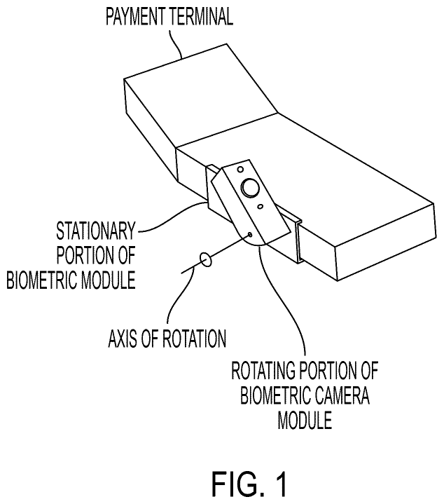

FIG. 1 shows a general configuration of a payment terminal with a biometric unit mounted thereon. The biometric unit is comprised of a stationary portion or bracket that can attach to the existing payment terminal, and a camera portion attached to the bracket. The camera portion can rotate in one or more axes to allow the camera to be positioned as desired to accomplish identification.

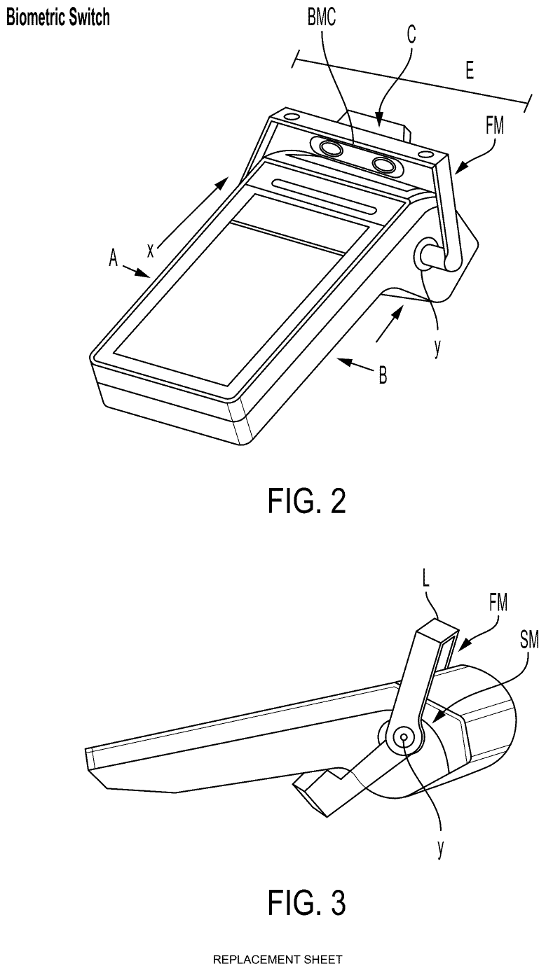

FIG. 2 shows the biometric unit of the present invention which can be attached to a payment terminal. The unit is comprised of a substantially C-shaped body C, which is made of rigid material. One end of the body C is identified as A, and the other end as B. An imaginary axis E connects the ends A and B of the body C as shown in FIG. 2. The feet F are individually denoted with X and Y as seen in FIG. 2. The distance between points A and B can and will vary, but can be between 2.75 and 3.25 inches, and 6 and 8 inches to align with the width of the payment terminal.

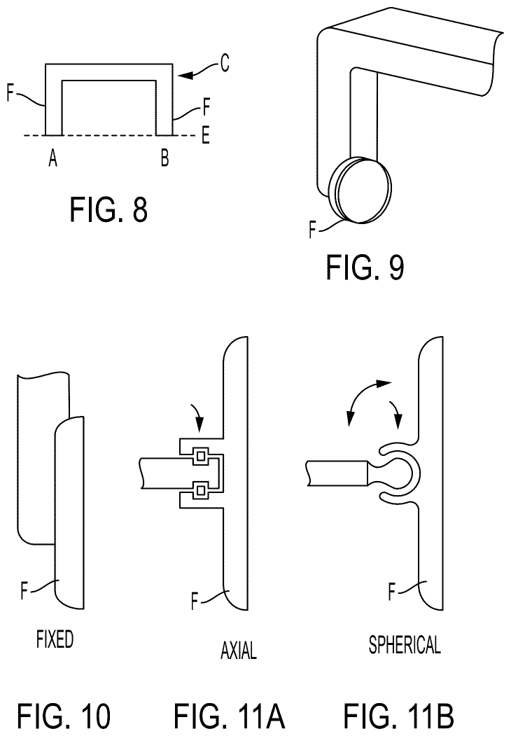

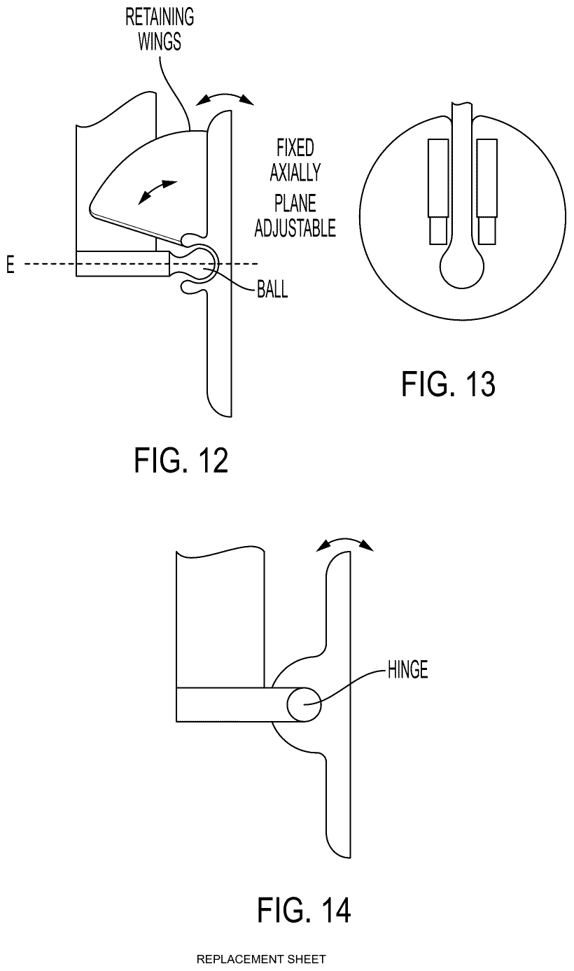

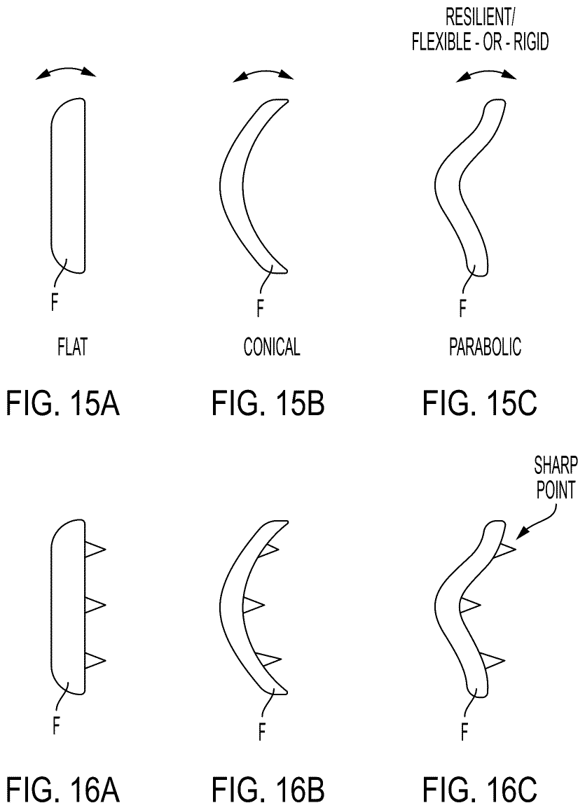

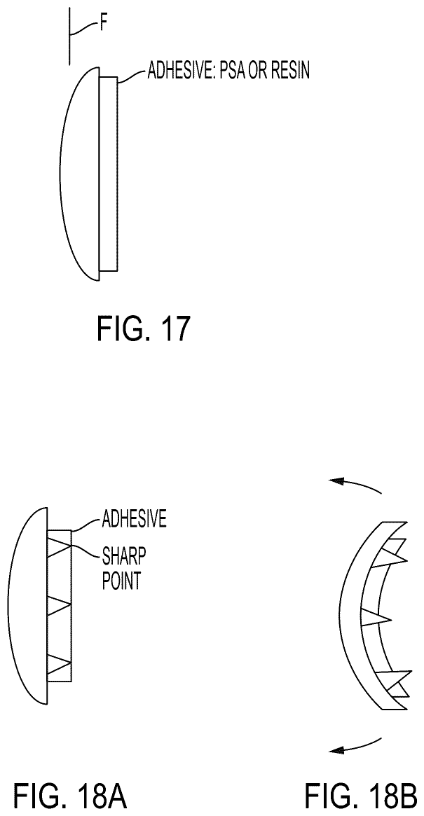

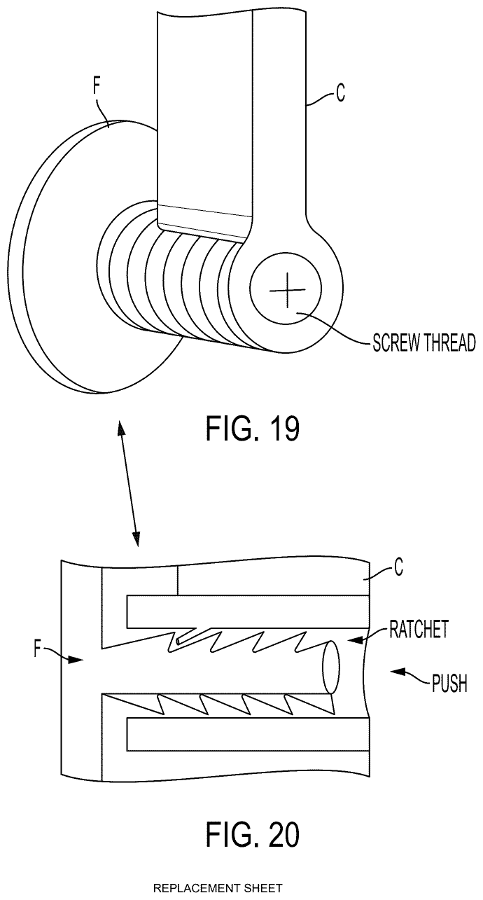

As seen in FIGS. 8-11, the body C has two opposing feet F, one on each end A and B of the body C, with the axis E running therebetween. One foot F is fixed axially and fixed planarly relative to end A of the body C, and the other foot F is axially rotatable yet planarly fixed relative to end B of the body C. The feet F form the point of connection between the body C and the payment terminal. The feet F can be configured to connect in a variety of ways.

As shown in FIG. 11(b) one foot F can be connected spherically to the body C so that the body C can rotate but is still planarly fixed to the payment terminal. Alternatively, as shown in FIG. 11(a) one foot F can be connected with an axial connection to the body C so that the body C can rotate but is still planarly fixed to the payment terminal.

FIGS. 9 and 10 show that the feet F have a contact pad for connecting to the body C at ends A and B. The contact pad can have a variety of shapes it can be substantially flat, smooth, conical, parabolic, or other shapes. The contact pad can contain one, two, three sharp points, or a plurality of points for making contact with the payment terminal. Contact pads can be made from substantially rigid material, or from a substantially resilient material as needed depending on the nature of the connection to the payment terminal. The contact pads can comprise of a resilient pressure-sensitive adhesive from 0.01 to 0.1 inches thick to make contact with the payment terminal, or a curing adhesive such as epoxy, Cyanoacrylate, Methyl methacrylate can be applied.

The feet F can be axially adjustable using a screw thread mechanism, and/or axially adjustable using a ratcheting mechanism. These adjustments being fixable or adjustable, and allowing the fixation of the body to the payment terminal.

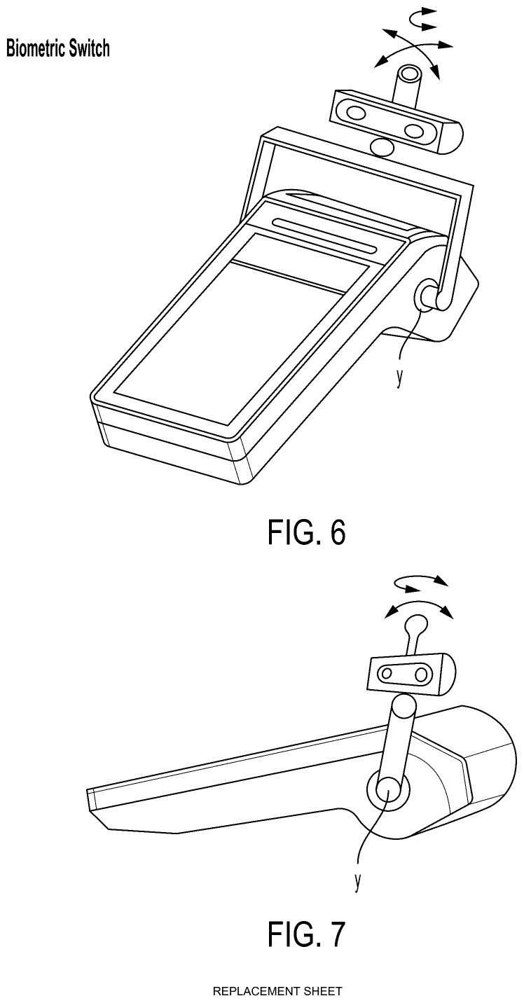

The body C contains fixed mounting FM (see FIG. 2) for the biometric capturing components BMC, located between the feet F. The biometric capturing components BMC include those referenced above, such as the various cameras, lenses, sensors, scanners, palm readers, optical devices, and the like. The fixed mounting FM is secured to the feet F by an axially rotatable mounting RM (see FIGS. 3-7). Thus, the BMC can be moved in multiple axes, by operation of the rotatable mounting RM and the circular/spherical mounting SM where the feet F meet the body C.

The body C and the FM, RM, and SM can be attached directly to the payment terminal using existing mounting mechanisms on the payment terminal with the methods described herein.

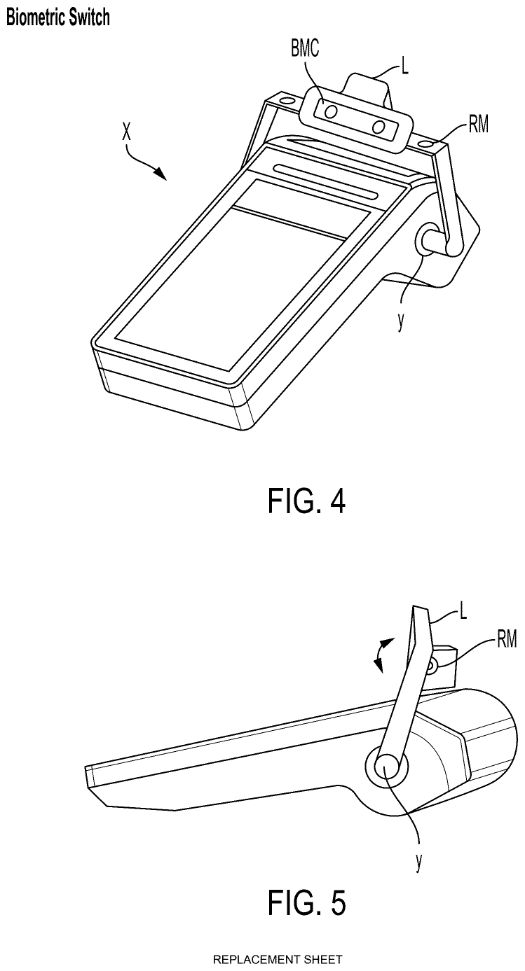

The housings of FM, RM, and SM includes an extension lever L for rotationally manipulating the biometric capturing components BMC contained on the fixed mounting (see FIGS. 4-7). The lever L can be hand operated to move/rotate the biometric capturing components as needed.

An intermediate coupling device can be provided to pass power and signals between the biometric capturing components BMC and the payment terminal while allowing the biometric capturing components to communicate with the payment terminal network.

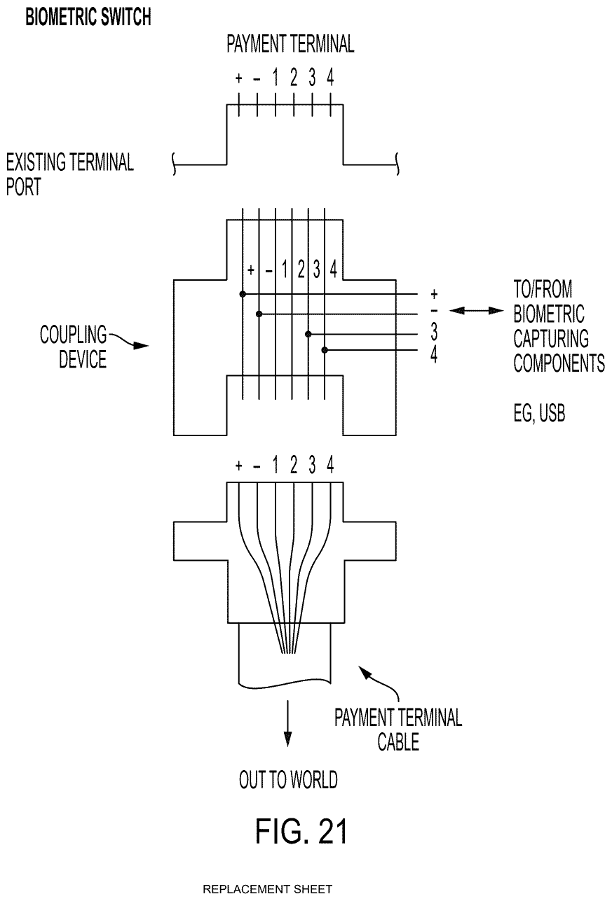

The above approaches and methods allow for a permanent, semi-permanent or temporary attachment of biometric capturing components to most any current and future payment terminal (see FIG. 21). It should be noted that this description uses an adjustable yet secure mounting bracket with included biometric capturing components BMC as an example of the current embodiment. This mechanism could be used in mechanical systems where permanent and semi-permanent mounting of an auxiliary component are desired.

Another embodiment of the invention is a payment terminal that accepts authentication from different biometric pay platforms. Prior art biometric pay platforms typically all run on different machines/platforms, which are generally incompatible with each other. The present invention includes a processor with dedicated secure areas for different biometric technologies. Examples of processors that can be used include QCS6490 (manufactured by Qualcomm) or similar products manufactured by Samsung, MediaTek, and Ambarello. The processor can have a secure area for image processing and communicate with the BAPS cloud; a separate secure area for performing anti-spoofing operations and communicate with the related cloud services (such as those provided by Amazon); and a third secure area for another platform to do anti-spoofing and matching on the processor itself.

The present invention includes novels approaches for a single payment machine that accept all forms of payment, including credit/debit cards, biometrics, and ACH. A device as described above solves these problems, however, given the wide variety of existing POS equipment. A further retrofit module is described herein that can adapt to the existing POS equipment, which allows for use of the biometric identification of the present invention without the need to replace existing POS devices.

The retrofit module is equipped with biometric capturing components BMC described above, including an RGB camera sensor, an RGB camera lens, IR camera sensor, IR camera lens, IR LED, an onboard microprocessor and operating system (SOC-System-on-Chip), and a means for connecting to the existing POS equipment such as one or more USB ports which can received a USB cable connected to the POS equipment. The retrofit module can be powered with a battery, by a connection to the POS equipment, or with a separate power chord. The retrofit module may also contain a distance sensor or proximity sensor, or both.

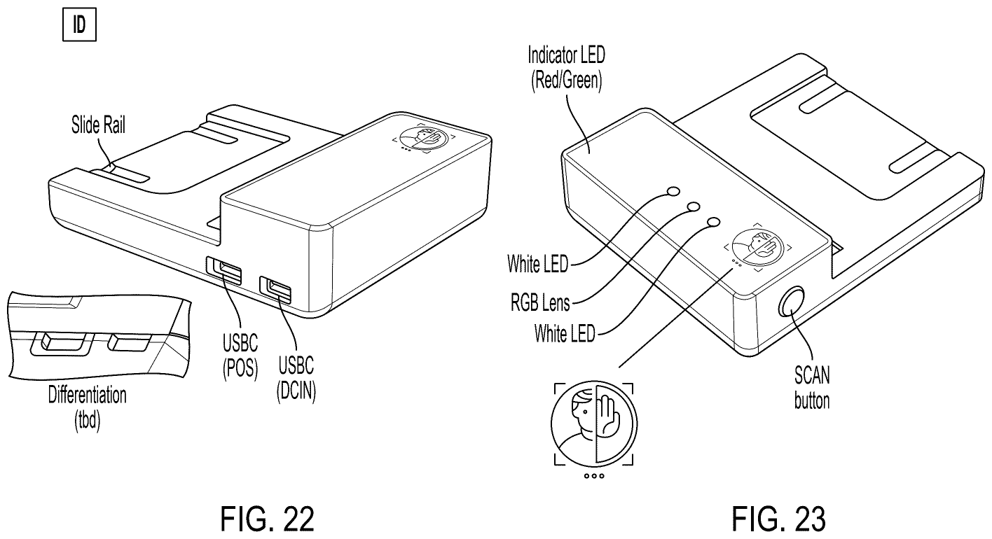

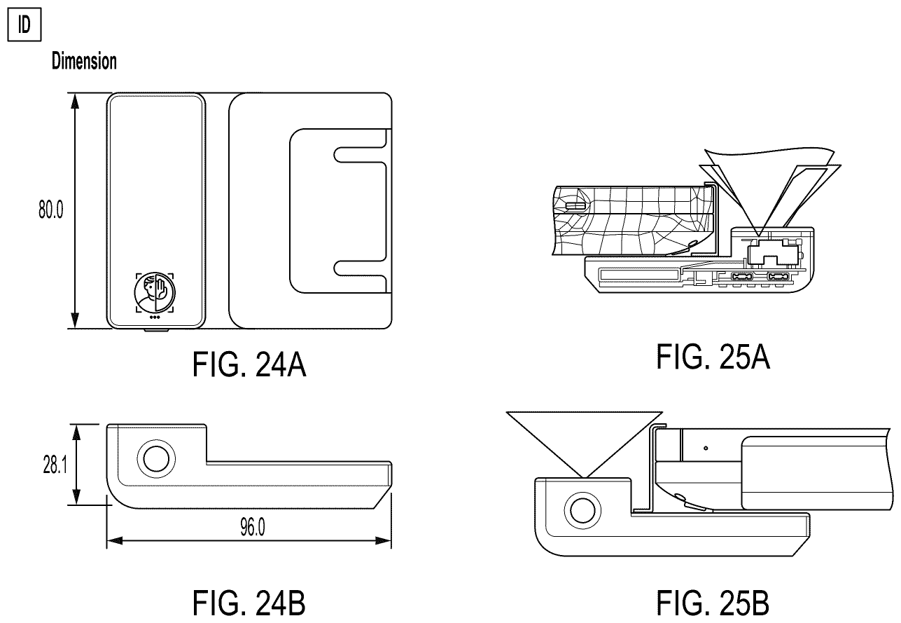

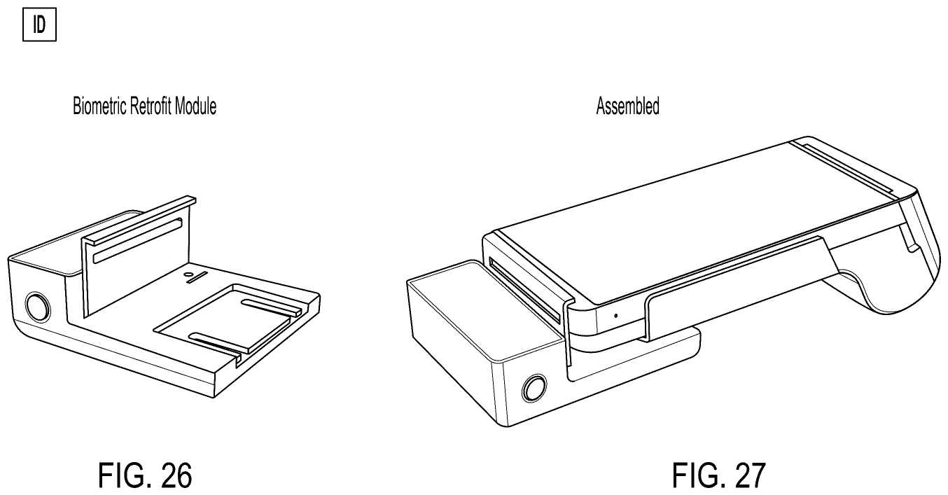

FIGS. 22-25 show one embodiment of the retrofit module of the present invention. The module has a slide rail to attach to the POS equipment and includes internally the components references above, as well as LED indicator lights, and a scan button to manually initiate a manual scan. The module attaches to the POS equipment to as shown in FIGS. 25a, 25b. Further, as shown in FIGS. 26 and 27 the module includes a wall bracket that can hold the POS system to the module. One end of the wall bracket has a ledge that snap fits over the edge of the POS equipment, and the other end of the wall bracket is affixed to the module with screws. In this manner, the module is affixed to the POS equipment.

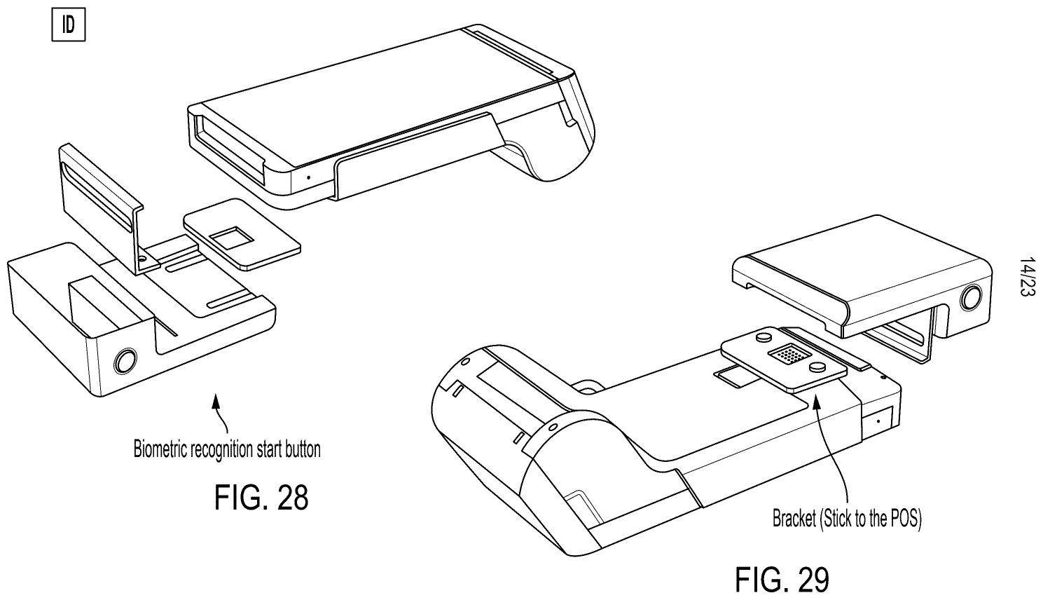

As shown in FIGS. 28 and 29, the module can be affixed to the POS equipment through the use of a bottom bracket. One side of the bottom bracket sides into the slide rail of the module and the other side attaches to the POS equipment through the use of an adhesive, or other means.

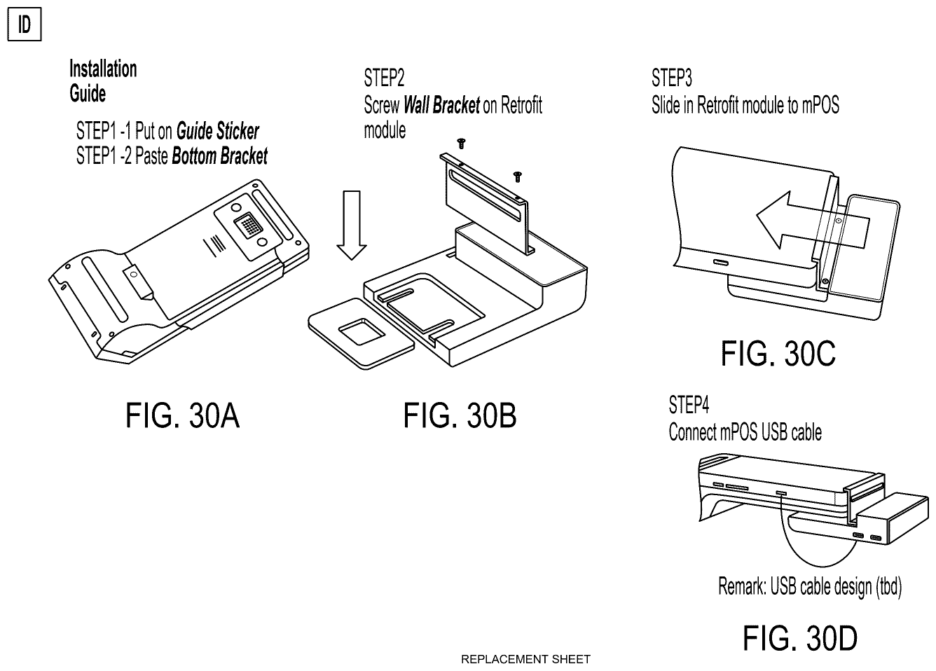

Preferably, the module is attached with both the wall bracket and the bottom bracket, as depicted in the installation guide shown in FIGS. 30a-d. In the first step the bottom bracket is attached to the POS equipment through the adhesive or other means. In the second step the wall bracket is attached to the module with the screws. In the third step the module slides into the POS equipment thereby securing the two. Finally, in the fourth step the USB cable connects the module to the POS equipment.

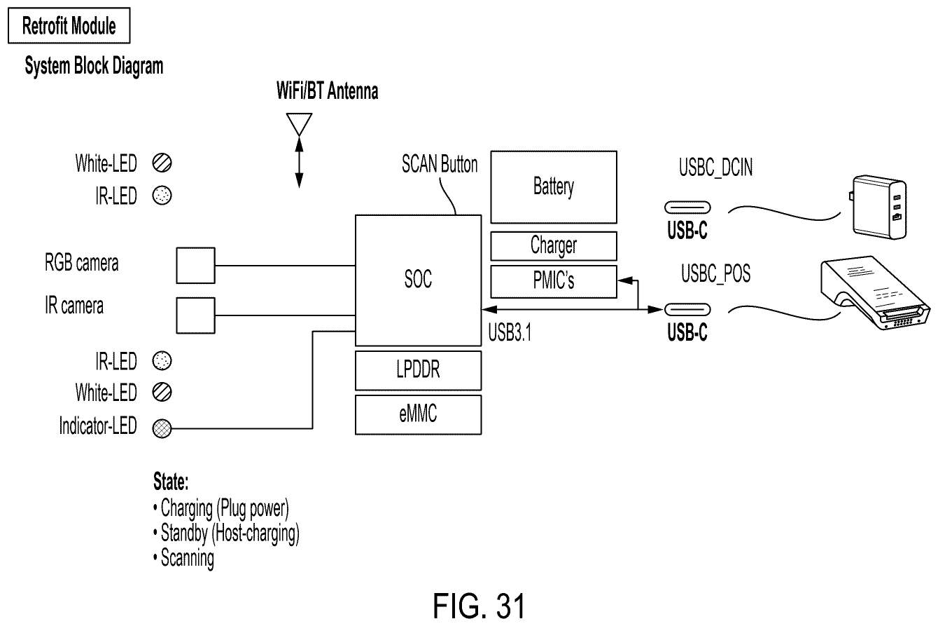

FIG. 31 is a block diagram of the schematics of the module. The module includes a WiFi/Bluetooth antenna to communicate with user devices. A SOC controller is provided along with memory components, including a synchronous dynamic random-access memory LDDR (Low-Power Double Data Rate), and an eMMC (embedded MMC) memory chip used as embedded non-volatile memory. The module includes a battery, charger unit, and power management integrated circuit (PMIC) to manage the power in the module. Also, shown are the cameras, LEDs, and connector cables.

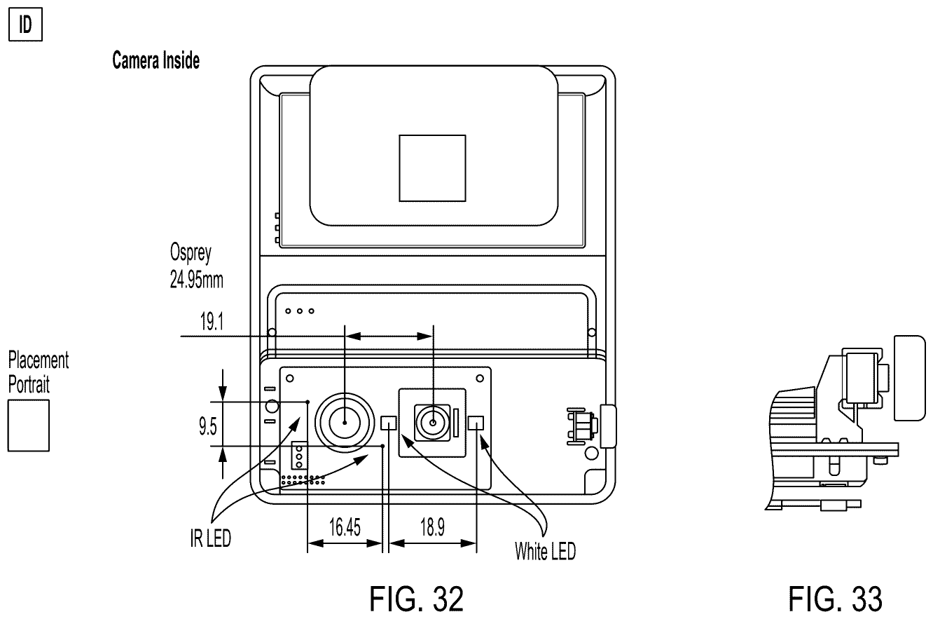

FIGS. 32 and 33 show the cameras, LEDs, and sensors, along with a partial view of the scan button.

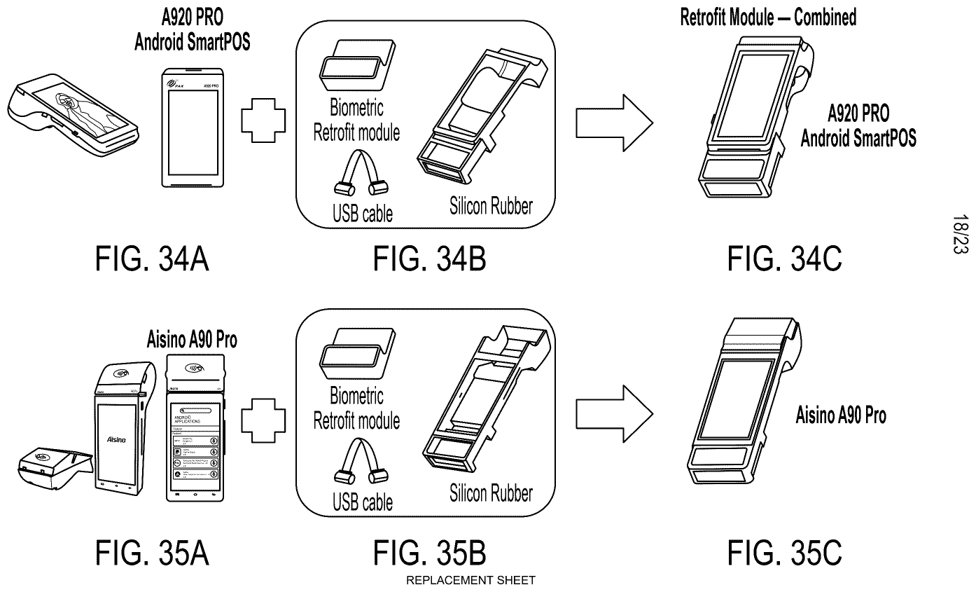

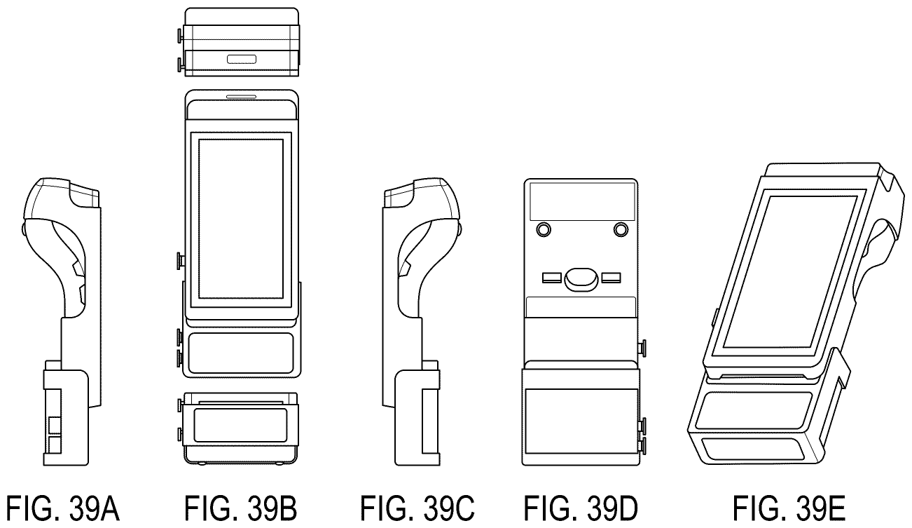

As noted above the retrofit module is designed to connect to and work with a variety of existing POS systems, which is facilitated by various modifications thereto as follows. FIGS. 34a-c and 35a-c show two such examples. FIG. 34 shows a case for use with a Pax Technologies, Inc. A920 Pro POS device. The case is made from silicon rubber and is sized to fit the POS device and the retrofit module. Further views of the case shown in FIG. 34 are shown in FIGS. 39a-e, depicting the case alone and combined with the POS devices and the retrofit module.

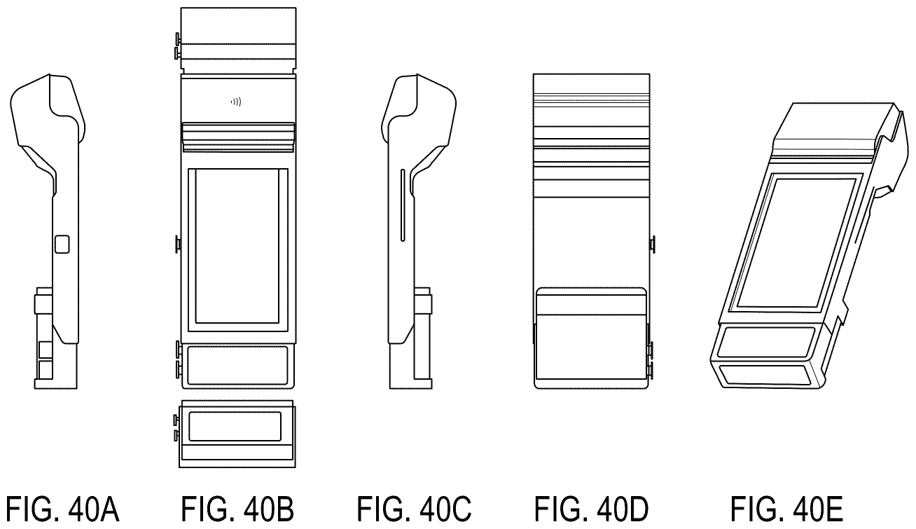

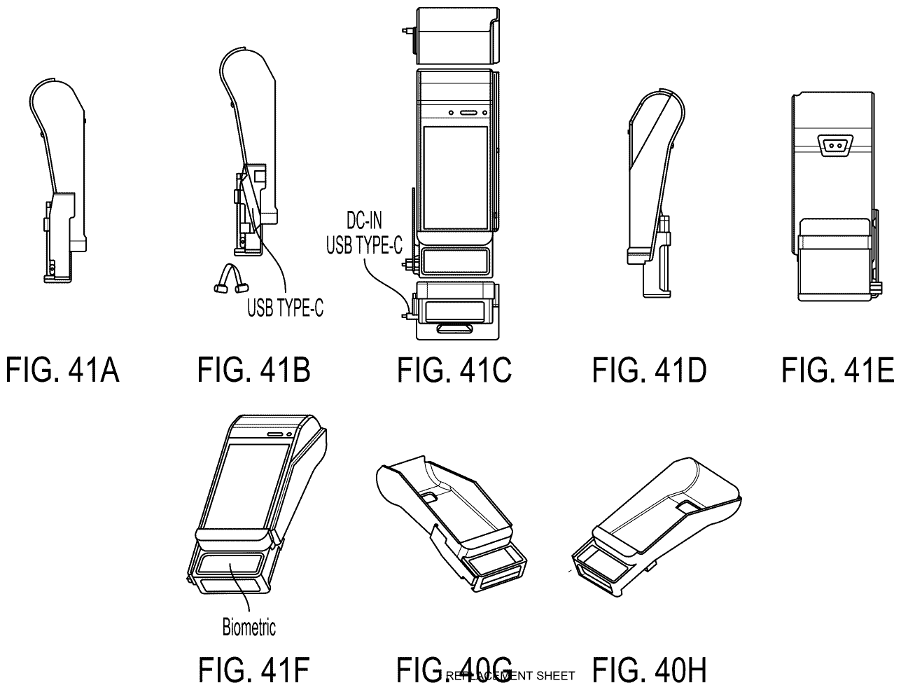

Similarly, FIG. 35 shows a silicon rubber case for use with an Aisino A90 Pro POS device. Further view of the case shown in FIG. 35 are shown in FIGS. 40a-e, depicting the case alone and combined with the POS devices and the retrofit module.

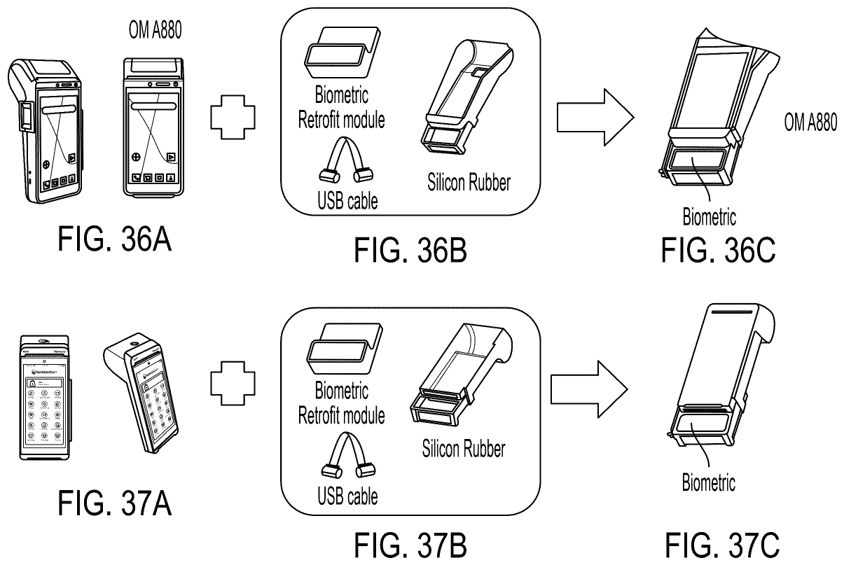

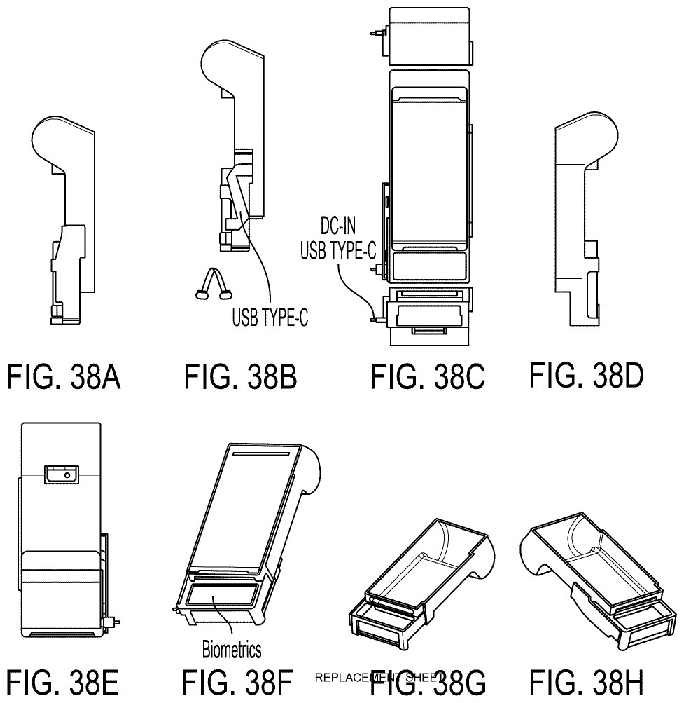

FIG. 36 shows a case for use with an Oma Emerites A880 POS device. Further view of the case shown in FIG. 36 are shown in FIGS. 41a-h, depicting the case alone and combined with the POS devices and the retrofit module.

FIG. 37 shows a case for use with a Newland N950 POS device. Further view of the case shown in FIG. 37 are shown in FIGS. 42a-h, depicting the case alone and combined with the POS devices and the retrofit module.

Of course, persons of ordinary skill in the art will appreciate that the retrofit module can be adapted to other POS systems.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

In order to securely attach the retrofit module, the existing back cover of the payment terminal can be removed and replaced with a new cover that includes a mounting point for the retrofit biometric camera module.

In order to ensure that the user is able to operate the payment terminal after the retrofit is installed, the retrofit biometric camera module may include buttons, e.g., volume buttons, that are mechanically connected to the buttons on the payment terminal such that the existing payment terminal buttons can be actuated by the buttons on the retrofit module.

In order to ensure that the payment terminal is able to charge in a docking cradle after the retrofit biometric camera module is installed, the retrofit biometric camera module may feature an outer form factor or an adapter that mimics in full or in part the current mechanical interface of the payment terminal to its cradle. In other implementations, the charging contacts may be replicated on the retrofit biometric camera module and an electrical connection established between those new contacts and the existing contacts on the payment terminal such that the payment terminal can be charged even after the retrofit biometric camera is installed.

In another implementation, the camera portion of the retrofit biometric camera module and is separate battery plus processor board are in separate enclosures with a flexible cable, e.g., a ribbon cable, running between the two pieces. In a further implementation, there are additional enclosure elements covering the flexible connection and extending between the camera portion and the battery plus processor board portion.

1. A method of biometric authentication associated with a transaction system, carried out under computer controlled programming means, comprising:
Creating a biometric account by having a user provide user identification information, transaction information, and biometric information for creating a registration image;
Creating a registration vector by processing the registration image with a biometrics processing algorithm;
Processing a transaction for the user on a transaction system comprising a biometric identification module;
Taking a transaction image of the user with the biometric identification module;
Creating a transaction vector by processing the transaction image with the biometrics processing algorithm;
Matching the transaction vector and the registration vector; and
Authenticating the transaction if the user's transaction vector and registration vector match.

2. The method of claim 1 comprising the step of conducting a liveness check to determine if the registration and transaction images are of an actual person.

3. The method of claim 2 where the liveness check requires the user to carry out one or more motions.

4. The method of claim 1 where a user's mobile device is used to take the registration image and the mobile device interfaces with the system creating the biometric account.

5. The method of claim 4 where the registration vector is stored on the user's mobile devices and is transmitted therefrom for authentication.

6. The method of claim 1 where the authenticating step is conducted by comparing the transaction vector to a database of registration vectors.

7. The method of claim 6 where database sharding is used to reduce the number of comparisons.

8. The method of claim 1 where the biometric account further comprises payment information and the transaction comprised payment for goods or services if the transaction is authenticated.

9. The method of claim 8 where the transaction system if a POS system.

10. The method of claim 9 where the biometric information comprises a unique identifier that conveys the type of POS system being used.

11. The method of claim 1 where the registration and transaction vectors utilize images of the user's iris.

12. The method of claim 1 where the biometric information includes location information.

13. The method of claim 1 where the biometric information includes a palm scan used for creating the registration and transaction vectors.

14. The method of claim 1 where the authentication step includes a thresholding technique to resolve differences between multiple matches.

15. The method of claim 1 where the biometric information includes a user specific PIN code.

16. A biometric module for retrofitting a payment system, comprising:
A body having a plurality of feet to secure to a device of the payment system;
A biometric device secured to the body; and
An electrical and/or data connection to the device.

17. The module of claim 16 where the feet pivot.

18. The module of claim 16 where the body pivots.

19. The module of claim 16 where the biometric device comprises one or more of the following, a camera, lens, sensor, scanner, palm reader, or optical device.

20. A biometric module for retrofitting a payment system, comprising:
A body;
A slide rail for securing to a bottom of a payment device of the payment system;
A wall bracket for securing to a top of the payment device;
A biometric module; and
An electrical and/or data connection to the device.

21. The module of claim 20 further comprising a guide sticker that affixes between the bottom of the payment device and fits into the slide rail.

22. The module of claim 21 where the guide sticker is affixed with adhesive.

23. The module of claim 20 where the wall bracket has a ledge that fits over the payment device.

24. The module of claim 23 where the wall bracket affixes to the body with screws.

25. The module of claim 20 where the connection is a USB cable.

26. The module of claim 20 where the biometric module comprises one or more of the following, a RGB camera sensor, a RGB camera lens, IR camera sensor, IR camera lens, IR LED, an antenna, and an onboard microprocessor and operating system.

27. A biometric module for retrofitting a payment system, comprising:
A body;
A biometric module;
A case for securing the biometric module and a payment device of the payment system; and
An electrical and/or data connection to the device.
